(19) United States
(12) Patent Application Publication
(10) Pub. No.: US 2024/0417288 A1
(43) Pub. Date: Dec. 19, 2024

(54) ELECTRODE WATER RECOVERY METHOD AND METHOD FOR PRODUCING ULTRAPURE WATER OR PHARMACEUTICAL WATER

(71) Applicant: Nomura Micro Science Co., Ltd., Atsugi-Shi, Kanagawa (JP)

(72) Inventors: Toshikazu ABE, Atsugi-Shi, Kanagawa (JP); Norihiko SUZUKI, Atsugi-Shi, Kanagawa (JP); Shuhei TORIMURA, Atsugi-Shi, Kanagawa (JP); Takatsugu KITO, Atsugi-Shi, Kanagawa (JP)

(73) Assignee: Nomura Micro Science Co., Ltd., Atsugi-Shi, Kanagawa (JP)

(21) Appl. No.: 18/702,349

(22) PCT Filed: Sep. 1, 2022
(86) PCT No.: PCT/JP2022/033034

§ 371 Date: Apr. 18, 2024

(30) Foreign Application Priority Data
Oct. 19, 2021 (JP) 2021-171016

(51) Int. Cl. C02F 1/469; C02F 103/04

(52) U.S. Cl. CPC C02F 1/4695; C02F 2103/04; C02F 2209/42

(57) ABSTRACT

An electrode water recovery method is an electrode water recovery method for removing hydrogen gas from electrode water generated by passage of water to be treated through a cathode chamber in an electric deionization treatment and recovering the electrode water in an ultrapure water production step, in which the electrode water is sprayed onto a filling material with which a scrubber is filled, an inert gas is supplied from below the filling material to react with the hydrogen gas in the electrode water, a treated gas generated by the reaction is exhausted from an exhaust port above the filling material, and treated water from which the hydrogen gas has been removed is recovered.

### TECHNICAL FIELD

The present disclosure relates to an electrode water recovery method and a method for producing ultrapure water or pharmaceutical water.

### BACKGROUND ART

An electric deionization device is widely used in the production of pharmaceutical water such as pure water, ultrapure water, purified water, and water for injection. In this device, an electric field applied from the outside to water to be treated desalts an ion component in the water to obtain treated water, and electrode water is generated by discharging concentrated water in which the removed ions are concentrated and the water to be treated in contact with an electrode to which the electric field is applied. In some devices, the concentrated water and the electrode water may be discharged as a mixture.

The concentrated water contains ions at a high concentration, and the electrode water may contain hydrogen or oxygen generated in a case in which an electric field is applied. However, it has been attempted to increase the usage rate of the water by recovering and reusing the discharged water.

For example, Japanese Patent Application Laid-Open (JP-A) No. H4-166215 discloses, as a method for treating electrode water containing hydrogen gas discharged from an electric deionization device, a technique of causing electrode water to pass through a column filled with a catalyst in an upward flow, and reacting the hydrogen gas with oxygen gas using a noble metal catalyst to generate water, thereby removing the hydrogen gas.

### SUMMARY OF INVENTION

### Technical Problem

By removing the hydrogen gas from the electrode water containing the hydrogen gas and recovering the electrode water, the water can be safely reused. By recovering the electrode water, pure water, ultrapure water, and pharmaceutical water can be efficiently produced.

However, as in the conventional example described above, the use of the catalyst for removing the hydrogen gas increases the cost. In order to cause the water to be treated to pass through the catalyst, a pump for pressurization is required, which further increases the cost. In general, since the amount of the electrode water is, for example, about 5 to 10% of the water to be treated, an improvement in a water recovery rate by recovery is expected to be only about 5 to 10%, and thus this cost increase is a major problem.

In general, the pure water is produced by storing, in a pretreatment pit, pretreated water obtained by pretreating raw water stored in a pit by flocculation precipitation, an activated carbon treatment, or gravity filtration or the like as pretreated water, and treating the pretreated water with a two-bed three-tower device, a reverse osmosis device, an electric deionization device, a mixed-bed ion exchange device, an ultraviolet treatment device, or a degassing device or the like. The ultrapure water is produced by storing pure water (primary treated water) in a pure water tank, and further treating the pure water with an ultraviolet treatment device, a degassing device, a mixed bed ion exchange device, or an UF filtration device or the like. Since the scale of production is particularly large in the case of pure water or ultrapure water, the amount of water is large even if a small proportion of water is recovered, and thus an improvement in water recovery is often a major problem.

The purified water is produced by a treatment with a reverse osmosis device, an electric deionization device, or a mixed bed ion exchange device or the like. The water for injection is produced in a state where purified water is distilled or treated with an UF filtration device and heated to 80° C. Although the production scale of pharmaceutical water is not so large, an improvement in the water recovery rate is still a problem.

An object of the disclosure is to increase the recovery rate of electrode water while suppressing an increase in cost.

### Solution to Problem

An electrode water recovery method according to a first aspect is an electrode water recovery method for removing hydrogen gas from electrode water generated by passage of water to be treated through a cathode chamber in an electric deionization treatment and recovering the electrode water in an ultrapure water production step, in which the electrode water is sprayed onto a filling material with which a scrubber is filled, an inert gas is supplied from below the filling material to react with the hydrogen gas in the electrode water, a treated gas generated by the reaction is exhausted from an exhaust port above the filling material, and treated water from which the hydrogen gas has been removed is recovered.

In the electrode water recovery method, the hydrogen gas is removed from the electrode water containing the hydrogen gas in the scrubber, and treated water from which the hydrogen gas has been removed is recovered. The electrode water sprayed on the filling material of the scrubber moves downward by gravity along the filling material. During that time, the hydrogen gas contained in the electrode water reacts with the inert gas and is removed. Therefore, it is possible to efficiently recover the electrode water (treated water) from which the hydrogen gas has been removed as compared with a case in which the electrode water is caused to pass through a catalyst.

An electrode water recovery method according to a second aspect is the electrode water recovery method according to the first aspect, in which the treated water from which the hydrogen gas has been removed is recovered by being drained from a drainage portion below the filling material by gravity.

In this electrode water recovery method, the treated water from which the hydrogen gas has been removed is discharged and recovered by gravity, and thus a pump for feeding liquid is unnecessary.

An electrode water recovery method according to a third aspect is the electrode water recovery method according to the first aspect, in which the treated water is stored in a liquid tank provided below the filling material in the scrubber, a water level of the liquid tank is detected by a water level sensor, and a valve provided in a drainage portion of the liquid tank is opened and closed so that the water level to be maintained is a predetermined water level.

In this electrode water recovery method, the valve of the drainage portion is opened and closed so that the water level of the liquid tank to be maintained is a predetermined water level. As a result, the inert gas supplied under the filling material is prevented from flowing out of the drainage portion, and thus the inert gas is directed to the filling material above the inert gas and reacts with the hydrogen gas. Therefore, the hydrogen gas can be efficiently removed.

An electrode water recovery method according to a fourth aspect is the electrode water recovery method according to the first aspect, in which the treated water is stored in a liquid tank provided below the filling material in the scrubber, a drainage portion of the liquid tank includes an upward pipe extending upward from a drainage port opened in the liquid tank, and a downward pipe folded back from an upper end of the upward pipe and extending downward, and in a case in which water sealing is formed in the upward pipe, and a water level of the liquid tank exceeds the upper end of the upward pipe, the treated water overflows and flows to the downward pipe.

In this electrode water recovery method, the drainage portion includes the upward pipe and the downward pipe, and in a case in which the water level of the liquid tank exceeds the upper end of the upward pipe, the treated water overflows and flows to the downward pipe. In a case in which the water level of the liquid tank does not reach the upper end of the upward pipe, the treated water is not drained. Once the treated water is stored until the water level of the liquid tank becomes higher than the drainage port of the upward pipe opened in the liquid tank, water sealing is formed in the upward pipe. As a result, the inert gas supplied under the filling material is prevented from flowing out of the drainage portion, and thus the inert gas is directed to the filling material above the inert gas and reacts with the hydrogen gas. Therefore, the hydrogen gas can be efficiently removed.

A method for producing ultrapure water or pharmaceutical water according to a fifth aspect, in which treated water recovered by the electrode water recovery method according to any one of the first to fourth aspects is reused for producing ultrapure water.

In this method for producing ultrapure water or pharmaceutical water, the treated water obtained by removing the hydrogen gas from the electrode water is recovered, and the treated water is reused for producing ultrapure water, so that water resources can be effectively utilized.

A method for producing ultrapure water or pharmaceutical water according to a sixth aspect is the method for producing ultrapure water or pharmaceutical water according to the fifth aspect, in which the recovered treated water is returned to a pit that stores raw water or a pit that stores pretreated water.

### Advantageous Effects of Invention

According to the disclosure, it is possible to increase the recovery rate of electrode water while suppressing an increase in cost.

### BRIEF DESCRIPTION OF DRAWINGS

FIG. 1 is a schematic configuration diagram illustrating an ultrapure water production system.

FIG. 2 is a schematic configuration diagram illustrating the configuration and action of an electric deionization treatment device.

FIG. 3 is a cross-sectional view schematically illustrating an example of a scrubber and a drainage portion.

FIG. 4 is a cross-sectional view schematically illustrating another example of a scrubber and a drainage portion.

### DESCRIPTION OF EMBODIMENTS

Embodiments of the disclosure will be described below with reference to the drawings. In the drawings, components denoted by the same reference numerals mean the same or similar components. Note that overlapping descriptions and reference numerals in the embodiments described below may be omitted. All the drawings used in the following description are schematic, and dimensional relationships of respective elements, and ratios of respective elements, and the like illustrated in the drawings do not necessarily coincide with actual ones. The dimensional relationships of the respective elements, and the ratios of the respective elements, and the like do not necessarily coincide among the plurality of drawings.

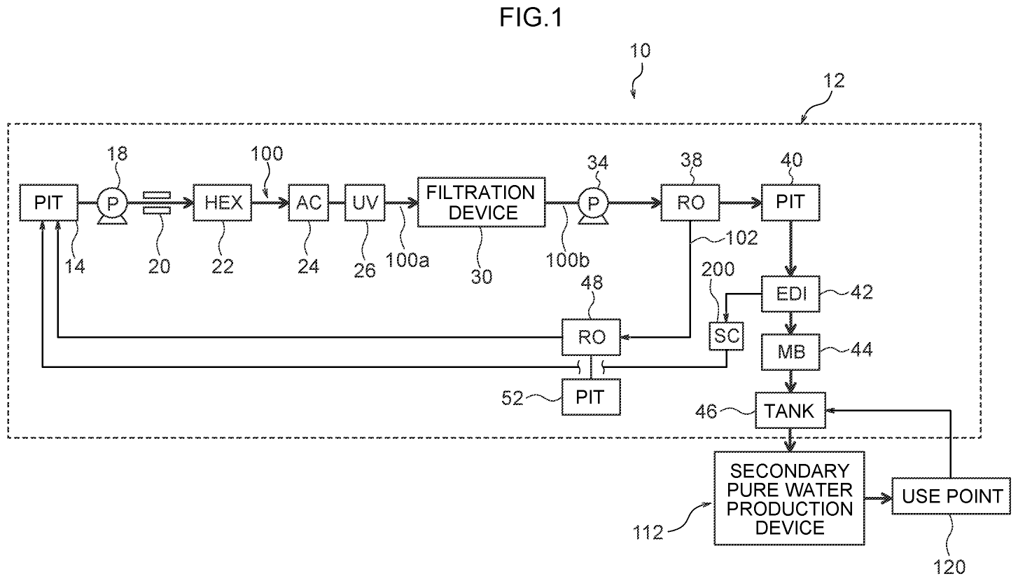

In FIGS. 1 to 4, an electrode water recovery method and a method for producing ultrapure water according to the embodiment will be described. An ultrapure water production system 10 using these methods includes a primary pure water device 12 and a secondary pure water device 112. Note that the configuration of the ultrapure water production system 10 is an example, and portions not related to the electrode water recovery method according to the embodiment may be changed as appropriate.

### (Primary Pure Water Device 12)

As illustrated in FIG. 1, the primary pure water device 12 includes a to-be-treated water pit 14 in which water to be treated is stored, a first pump 18, a flow meter (FIQ) 20, a heat exchanger (HEX) 22, an activated carbon device (AC) 24, and an ultraviolet oxidation device (UV) 26. The primary pure water device 12 further includes a second pump 34, a first reverse osmosis membrane device (RO) 38, a deionized water pit 40, an electric deionization device (EDI) 42, an ion exchange resin device 44, a scrubber 200, and a pure water tank 46.

The to-be-treated water pit 14, the first pump 18, the flow meter 20, the heat exchanger 22, the activated carbon device 24, the ultraviolet oxidation device 26, the second pump 34, the first reverse osmosis membrane device 38, the deionized water pit 40, the electric deionization device 42, the ion exchange resin device 44, and the pure water tank 46 are arranged along a main flow path 100 through which the water to be treated flows in this order from an upstream side in the flow direction of the water to be treated.

Each device will be described below.

The to-be-treated water pit 14 stores the water to be treated. The water to be treated is raw water, and examples of the water to be treated include industrial water, tap water, groundwater, river water, and well water. The first pump 18 causes the water to be treated stored in the to-be-treated water pit 14 to flow to a downstream side in the flow direction of the water to be treated (hereinafter, may be referred to as “water flow direction”) along the main flow path 100.

The flow meter 20 measures the flow rate of the water to be treated flowing through the main flow path 100. The heat exchanger 22 adjusts the temperature of the water to be treated by heat exchange. The activated carbon device 24 removes a natural organic matter, residual chlorine and trihalomethane and the like from the water to be treated by an adsorption treatment. The ultraviolet oxidation device 26 decomposes and sterilizes viable organism and bacteria and the like contained in the water to be treated by ultraviolet irradiation.

The second pump 34 is a high-pressure pump, and causes the water to be treated from which impurities have been removed by a filtration device 30 to flow to the first reverse osmosis membrane device 38.

The first reverse osmosis membrane device 38 is provided with a reverse osmosis membrane through which water to be treated permeates, and the first reverse osmosis membrane device 38 separates the water to be treated into permeated water from which ions and salts have been removed and concentrated water by a reverse osmosis membrane treatment.

The deionized water pit 40 temporarily stores the permeated water that has permeated through the reverse osmosis membrane of the first reverse osmosis membrane device 38. The electric deionization device 42 performs a deionization treatment while electrically regenerating the water to be treated (stored water in the deionized water pit 40), and discharges electrode water mixed with concentrated water (described as electrode water) and treated water. The scrubber 200 removes hydrogen gas from the electrode water discharged from the electric deionization device 42. The ion exchange resin device 44 removes inorganic ions remaining in a trace amount in the water to be treated flowing out of the electric deionization device 42. The pure water tank 46 stores primary pure water produced by the primary pure water device 12.

### [Electric Deionization Device 42]

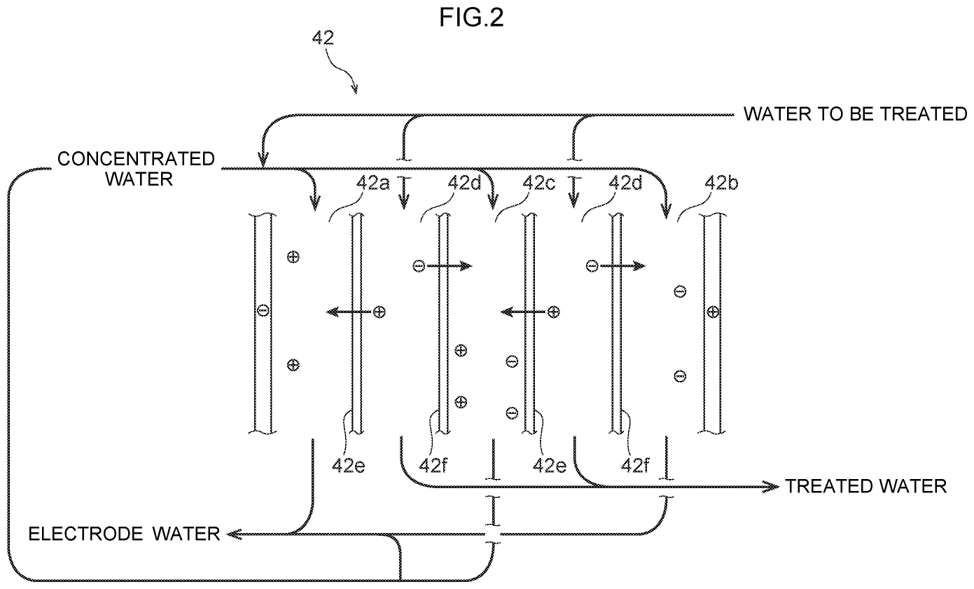

In FIG. 2, the electric deionization device 42 includes a cathode chamber 42a and an anode chamber 42b disposed opposite to each other, and a concentration chamber 42c and a desalination chamber 42d partitioned by an ion exchange membrane are alternately disposed therebetween. Each of the cathode chamber 42a and the anode chamber 42b is adjacent to the concentration chamber 42c. In the illustrated example, as the ion exchange membrane, a cation exchange membrane 42e and an anion exchange membrane 42f are alternately arranged from the cathode chamber 42a side toward the anode chamber 42b side. The desalination chamber 42d is filled with an ion exchange resin (not illustrated).

Water to be treated is caused to pass through the desalination chamber 42d, and mixed water of the water to be treated and concentrated water is caused to pass through the concentration chamber 42c, the cathode chamber 42a, and the anode chamber 42b. The ions in the water to be treated are adsorbed by the ion exchange resin in the desalination chamber 42d, and move through the ion exchange membrane from the desalination chamber 42d toward the concentration chamber 42c by an applied DC potential force. As the water to be treated moves in the desalination chamber 42d, the ions are removed. The removed ions move to the concentrated water, anode water, and cathode water. The concentrated water discharged from the concentration chamber 42c is partially mixed with the electrode water and discharged, and the rest is circulated to the concentration chamber 42c. The electrode water passing through the cathode chamber 42a and the anode chamber 41b is discharged as the electrode water. The electrode water containing a relatively large amount of hydrogen gas is sent to the scrubber 200. The concentrated water discharged from the electric deionization device 42 may be mixed with the electrode water and sent to the scrubber 200 without being returned to the to-be-treated water pit 14. That is, the liquid supplied to the scrubber 200 is not limited to the electrode water, and may be water obtained by mixing the electrode water and the concentrated water.

The configuration of the electrical deionization device is not limited to the present configuration.

The concentrated water is not necessarily circulated. The concentration chamber 42c, the anode chamber 42b, and the cathode chamber 42a may be filled with a conductive substance such as an ion exchange resin or an ion exchange fiber.

As the ion exchange resin with which the desalination chamber 42d is filled, it is preferable to use a mixture of a cation exchange resin and an anion exchange resin, but the ion exchange resin is not limited to this combination. A conductive substance such as another ion exchange resin or ion exchange fiber may be filled singly or in mixture thereof.

As the electric deionization device, a commercially available electric deionization device can be used without particular limitation. Examples thereof include MK series (manufactured by E-Cell) and VNX series (manufactured by IONPURE).

### [Scrubber 200]

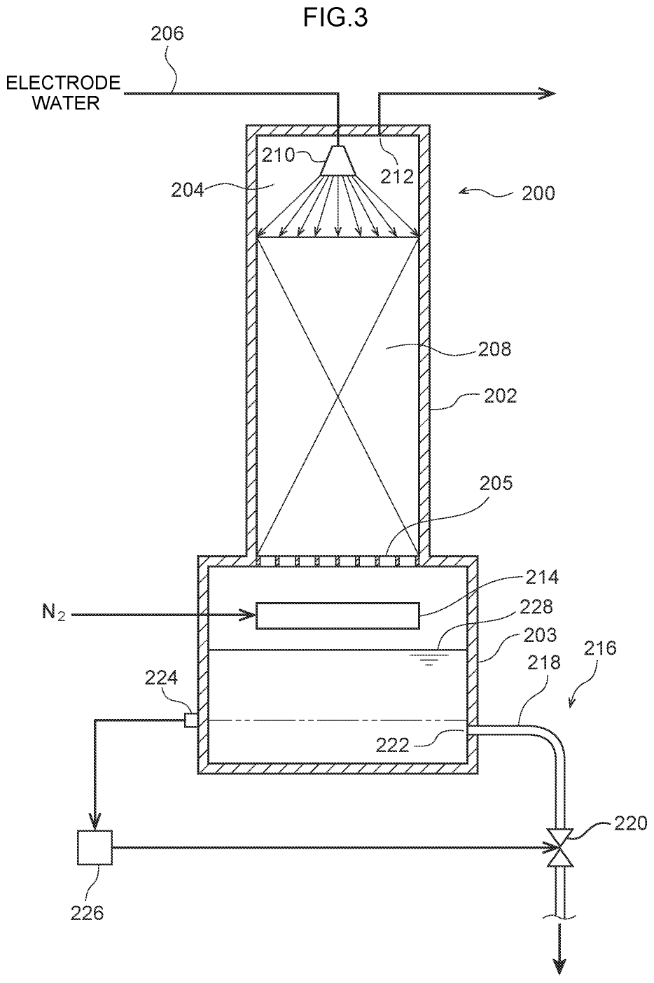

FIG. 3 illustrates an example of the scrubber 200. The scrubber 200 is an example of a degassing device, and includes, for example, a cylindrical degassing tower 202 and a liquid tank 203 disposed below the degassing tower 202. A spray portion 204 is provided in the upper portion of the degassing tower 202. A water supply pipe 206 for introducing electrode water into the degassing tower 202 is connected to the spray portion 204. The electrode water flows into the scrubber 200 by the discharge pressure of the electric deionization device 42. A perforated plate 205 is provided in the lower part of the degassing tower 202. The perforated plate 205 has a vent through which gas and liquid flow, and partitions the degassing tower 202 and the liquid tank 203. A predetermined amount of filling material 208 is disposed on the perforated plate 205. An exhaust port 212 is provided above the filling material 208 in the degassing tower 202, for example, in a ceiling portion. For example, TERARETTO (registered trademark) can be used as the filling material 208.

The spray portion 204 includes a spray nozzle 210. The spray nozzle 210 is disposed directly above the filling material 208 in the central portion of the degassing tower 202. The spray nozzle 210 can spray the electrode water in a wide angle mist form (fine particle form) and supply the electrode water to the entire surface of the filling material 208.

A gas disperser 214 is provided in the upper portion of the liquid tank 203. Nitrogen gas as an example of an inert gas is supplied to the gas disperser 214. The nitrogen gas flows upward through a void portion formed by the filling material 208 toward the electrode water flowing downward from above in the degassing tower 202. The hydrogen gas in the electrode water is removed by gas-liquid contact between liquid flowing down on the surface of the filling material 208 and the nitrogen gas rising in the void portion of the filling material 208, using a gas partial pressure difference in each fluid as a driving force. After the hydrogen gas is removed by the filling material 208, the electrode water flows down into the liquid tank 203, is drained from the drainage portion 216 by gravity, and is returned to, for example, the to-be-treated water pit 14 (FIG. 1) to be recovered. Note that if the electrode water can be drained by gravity, the electrode water may be collected in an underground tank or the like (not illustrated) and reused. A treated gas containing the nitrogen gas reaching the upper portion of the degassing tower 202 and the hydrogen gas removed from the electrode water is discharged from the exhaust port 212. A recovered treated water 228 can be reused for the production of ultrapure water. As an inert gas, nitrogen, argon, or neon or the like can be used. In a case in which the operation can be performed under a condition that explosion can be avoided, the inert gas can be substituted by air. In a case in which the pit of the recovery destination of the recovered treated water 228 or the upper portion of the pit or tank of a pure water production process is filled with an inert gas, followed by scaling, the exhaust of the inert gas can also be used. For example, in a case in which the upper portion of the tank 46 in FIG. 1 is sealed with the nitrogen gas, the exhaust of the tank 46 can be used.

The drainage portion 216 includes, for example, a drainage pipe 218 formed in an L shape and a valve 220 provided in the drainage pipe 218. A drainage port 222 of the drainage portion 216 is opened to, for example, a side portion of the liquid tank 203. A water level sensor 224 for detecting the water level of the treated water 228 stored in the liquid tank 203 is provided on the side portion of the liquid tank 203. A signal from the water level sensor 224 is sent to a control portion 226. The control portion 226 opens and closes the valve 220 so that the water level to be maintained is a predetermined water level. For example, the control portion 226 opens the valve 220 in a case in which the water level of the treated water 228 is higher than the drainage port 222 of the drainage portion 216, and closes the valve 220 in a case in which the water level of the treated water 228 is not higher than the drainage port 222 of the drainage portion 216. An upper limit set value and a lower limit set value may be set for the water level of the liquid tank 203, the valve 220 may be closed in a case in which the water level of the treated water 228 is the lower limit set value, and the valve 220 may be opened in a case in which the water level of the treated water 228 exceeds the upper limit set value, so that the water level of the treated water 228 is kept between the upper limit set value and the lower limit set value. As the water level sensor, for example, a pressure sensor, a capacitance sensor, a differential pressure sensor, or a float sensor or the like can be used.

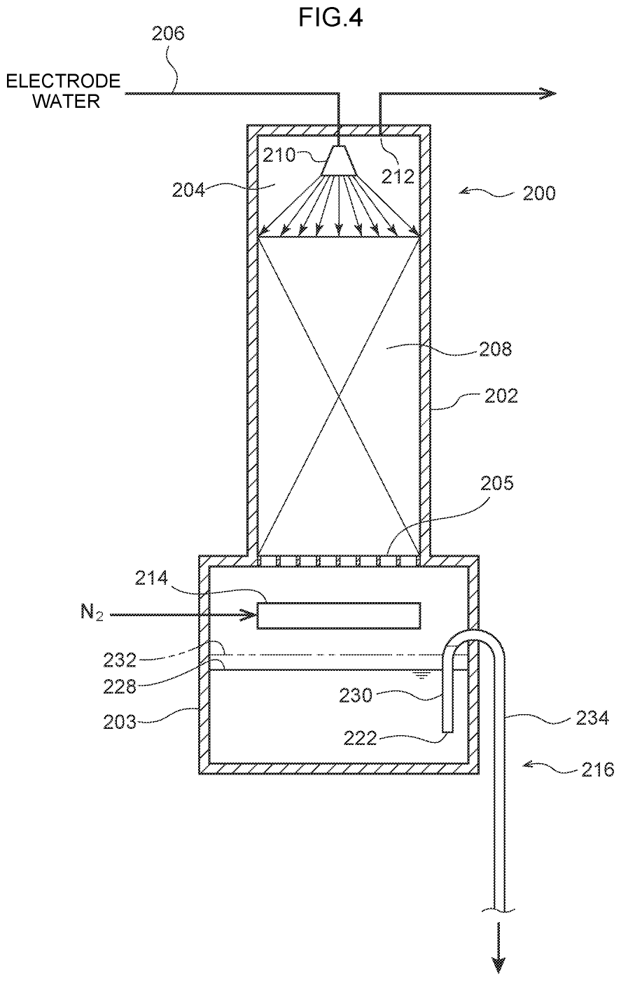

FIG. 4 illustrates another example of the scrubber 200. In the scrubber 200, the drainage portion 216 includes an upward pipe 230 extending upward from the drainage port opened in the liquid tank 203 and a downward pipe 234 folded back from the upper end of the upward pipe 230 and extending downward. Water sealing is formed in the upward pipe 230, and the treated water 228 overflows and flows to the downward pipe 234 in a case in which the water level of the liquid tank 203 exceeds the water level 232. The water level in the upward pipe 230 is slightly higher than the water level in the liquid tank 203 due to the pressure of the inert gas in the liquid tank 203, and thus, in a case in which the water level rises to the upper limit water level 232, overflow from the upward pipe 230 to the downward pipe 234 occurs. The other configurations are similar to those of the scrubber 200 of FIG. 3. In the device of FIG. 4, it is also possible to perform control by installing the valve or water level sensor similar to that in FIG. 3 as necessary.

### [Second Reverse Osmosis Membrane Device 48]

As illustrated in FIG. 1, a second reverse osmosis membrane device 48 is disposed in the middle of a branch flow path 102 branching from the first reverse osmosis membrane device 38. The branch flow path 102 is a flow path through which the concentrated water separated by the first reverse osmosis membrane device 38 flows, and includes one end connected to the first reverse osmosis membrane device 38 and the other end connected to the to-be-treated water pit 14.

The second reverse osmosis membrane device 48 is provided with a reverse osmosis membrane through which the concentrated water permeates, and the second reverse osmosis membrane device 48 separates the concentrated water separated by the first reverse osmosis membrane device 38 into treated water obtained by removing ions and salts from the concentrated water and wastewater by a reverse osmosis membrane treatment. The wastewater is stored in a wastewater pit 52, and the treated water is returned to the to-be-treated water pit 14.

In the first reverse osmosis membrane device 38 and/or the second reverse osmosis membrane device 48, when there is a concern that biofouling may occur in scale generation, a scale inhibitor, a slime control agent, and a pH adjusting agent and the like can also be added in the front stage of the first reverse osmosis membrane device 38. As the scale inhibitor, the slime control agent, and the pH adjusting agent, commercially available ones can be used without particular limitation. As an addition method, for example, an ejector can be installed in the front stage of the second pump 34 for injecting.

### [Ion Exchange Resin Device 44]

An ion exchange resin device 44 further removes an ion component remaining in the treated water of the electric deionization device 42 in the preceding stage. For example, a non-regeneration type mixed bed ion exchange resin tower is exemplified. For example, the ion exchange resin device 44 is filled with a mixture of a strongly acidic ion exchange resin and a strongly basic ion exchange resin, but it is also possible to mix another ion exchange resin such as a boron-selective ion exchange resin. Instead of the mixed bed type, a multilayer bed type can be used. It is also possible to use a single-bed multi-tower ion exchange device including two or more towers. The ion exchange resin exemplified here can also be used as a single bed. The configuration of the ion exchange resin device 44 can be optionally selected in consideration of the water quality of the treated water of the electric deionization device 42 and the water quality of the ultrapure water finally obtained. 20

### (Secondary Pure Water Device 112)

As illustrated in FIG. 1, the secondary pure water device 112 is disposed on the downstream side of the pure water tank 46 in a water flow direction.

In this configuration, the secondary pure water device 112 further removes impurities from the primary pure water. The ultrapure water obtained by the secondary pure water device 112 is sent to a use point 120 which is a use place. Among the ultrapure water sent to the use point 120, the unused ultrapure water is directly returned to the pure water tank 46 and stored in the pure water tank 46 together with the primary pure water.

### (Electrode Water Recovery Method)

The electrode water recovery method is an electrode water recovery method for removing hydrogen gas from electrode water generated by passage of water to be treated through a cathode chamber 42a in an electric deionization treatment and recovering the electrode water in an ultrapure water production step, in which the electrode water is sprayed onto a filling material 208 with which a scrubber 200 is filled, an inert gas is supplied from below the filling material 208 to react with the hydrogen gas in the electrode water, a treated gas generated by the reaction is exhausted from an exhaust port 212 above the filling material 208, and treated water 228 from which the hydrogen gas has been removed is drained from a drainage portion 216 below the filling material 208 by gravity to recover the treated water.

In this electrode water recovery method, the electrode water containing the hydrogen gas is caused to pass through the scrubber 200 by the discharge pressure of the electrode water from an electric deionization device 42, the hydrogen gas is removed in the scrubber 200, and the treated water 228 from which the hydrogen gas has been removed is discharged by gravity to recover the treated water, so that a pump for liquid feeding is unnecessary. The electrode water sprayed on the filling material 208 of the scrubber 200 moves downward by gravity along the filling material 208. During that time, the hydrogen gas contained in the electrode water reacts with the inert gas and is removed. Therefore, it is possible to efficiently recover the electrode water (treated water 228) from which the hydrogen gas has been removed as compared with the case in which the electrode water is caused to pass through the catalyst.

The treated water 228 is stored in the liquid tank 203 provided below the filling material 208 in the scrubber 200, the water level of the liquid tank 203 is detected by the water level sensor 224, and in a case in which the water level is higher than the drainage port of the drainage portion 216 opened in the liquid tank 203, the valve 220 provided in the drainage portion 216 may be opened.

In this case, when the water level of the liquid tank 203 is higher than the drainage port 222 of the drainage portion 216 opened in the liquid tank 203, the valve 220 of the drainage portion 216 is opened. In a case in which the water level of the liquid tank 203 is equal to or lower than the drainage port 222, the valve 220 is closed. As a result, the inert gas supplied under the filling material 208 is prevented from flowing out of the drainage portion 216, and thus the inert gas is directed to the filling material 208 above the inert gas and reacts with the hydrogen gas. Therefore, the hydrogen gas can be efficiently removed.

The treated water 228 may be stored in the liquid tank 203 provided below the filling material 208 in the scrubber 200, the drainage portion 216 may include an upward pipe 230 extending upward from the drainage port 222 opened in the liquid tank 203 and a downward pipe 234 folded back from an upper end 232 of the upward pipe 230 and extending downward, and in a case in which water sealing is formed in the upward pipe 230, and the water level of the liquid tank 203 exceeds the upper end 232 of the upward pipe 230, the treated water 228 may flow to the downward pipe 234.

In this case, the drainage portion 216 includes the upward pipe 230 and the downward pipe 234, and the treated water 228 flows to the downward pipe 234 in a case in which the water level of the liquid tank 203 exceeds the upper end 232 of the upward pipe 230. In a case in which the water level of the liquid tank 203 does not reach the upper end of the upward pipe 230, the treated water 228 is not drained. Once the treated water 228 is stored until the water level of the liquid tank 203 becomes higher than the drainage port 222 of the upward pipe 230 opened in the liquid tank 203, water scaling is formed in the upward pipe 230. As a result, the inert gas supplied under the filling material 208 is prevented from flowing out of the drainage portion 216, and thus the inert gas is directed to the filling material 208 above the inert gas and reacts with the hydrogen gas. Therefore, the hydrogen gas can be efficiently removed. Since the water level sensor 224 and the control portion 226 (FIG. 3) are not required, an increase in cost can be suppressed.

As described above, according to the electrode water recovery method according to the embodiment, it is possible to increase the recovery rate of the electrode water while suppressing an increase in cost.

In a case in which the electrode water is recovered as it is and reused for the production of pure water, ultrapure water, and pharmaceutical water, OH radicals and the like are consumed by hydrogen, and thus the performance of ultraviolet devices (ultraviolet oxidation device and ultraviolet sterilization device) incorporated in these production devices is deteriorated. It is possible to efficiently produce pure water, ultrapure water, and pharmaceutical water while avoiding this influence.

### (Method for Producing Ultrapure Water)

The method for producing ultrapure water reuses the treated water 228 recovered by the electrode water recovery method for producing ultrapure water in the ultrapure water production step using the ultrapure water production system 10.

In the method for producing ultrapure water, the treated water 228 obtained by removing the hydrogen gas from the electrode water is recovered and the treated water 228 is reused for producing ultrapure water, and thus water resources can be effectively utilized. In a case of using the embodiment, only the scrubber 200, some valves, and pipes are newly required, and it is possible to improve the water recovery rate while remarkably suppressing the cost.

The electrode water recovery method according to the embodiment can be used in an electric deionization device used for the production of pure water and ultrapure water for the production of semiconductors and liquid crystals and the like, and for the production of pharmaceutical and medicinal water such as purified water and water for injection.

### Other Embodiments

Although an example of the embodiment of the disclosure has been described above, the embodiment of the disclosure is not limited to the above, and it is a matter of course that various modifications can be made without departing from the gist of the disclosure in addition to the above.

The content of the disclosure by Japanese Patent Application No. 2021-171016 filed on Oct. 19, 2021 is herein entirely incorporated by reference.

All publications, patent applications, and technical standards mentioned in the specification are herein incorporated by reference to the same extent as if each individual publication, patent application, and technical standard were specifically and individually indicated to be incorporated by reference.

1. An electrode water recovery method for removing hydrogen gas from electrode water generated by passage of water to be treated through a cathode chamber in an electric deionization treatment and recovering the electrode water in an ultrapure water production step,
wherein the electrode water is sprayed onto a filling material with which a scrubber is filled, an inert gas is supplied from below the filling material to react with the hydrogen gas in the electrode water, a treated gas generated by the reaction is exhausted from an exhaust port above the filling material, and treated water from which the hydrogen gas has been removed is recovered.

2. The electrode water recovery method according to claim 1, wherein the treated water from which the hydrogen gas has been removed is recovered by being drained from a drainage portion below the filling material by gravity.

3. The electrode water recovery method according to claim 1, wherein the treated water is stored in a liquid tank provided below the filling material in the scrubber, a water level of the liquid tank is detected by a water level sensor, and a valve provided in a drainage portion of the liquid tank is opened and closed so that the water level to be maintained is a predetermined water level.

4. The electrode water recovery method according to claim 1, wherein
the treated water is stored in a liquid tank provided below the filling material in the scrubber,
a drainage portion of the liquid tank includes an upward pipe extending upward from a drainage port opened in the liquid tank, and a downward pipe folded back from an upper end of the upward pipe and extending downward, and
in a case in which water sealing is formed in the upward pipe, and a water level of the liquid tank exceeds the upper end of the upward pipe, the treated water overflows and flows to the downward pipe.

5. A method for producing ultrapure water or pharmaceutical water, wherein treated water recovered by the electrode water recovery method according to claim 1 is reused for producing ultrapure water.

6. The method for producing ultrapure water or pharmaceutical water according to claim 5, wherein the recovered treated water is returned to a pit that stores raw water or a pit that stores pretreated water.
